(19) United States
(12) Patent Application Publication
(10) Pub. No.: US 2007/0134149 A1
(43) Pub. Date: Jun. 14, 2007

(54) Spheroidizing agent of graphite

(75) Inventors: Masahiro Koike, Kikugawa-city (JP); Makoto Kitamura, Nagoya-city (JP)

Correspondence Address: STEPTOE & JOHNSON LLP, 1330 CONNECTICUT AVENUE, N.W., WASHINGTON, DC, 20036, US

(73) Assignee: Asahi Tec Corporation, Kikugawa-city (JP)

(21) Appl. No.: 11/529,215

(22) Filed: Sep. 29, 2006

(30) Foreign Application Priority Data
Dec. 7, 2005 (JP) 2005-354142
Jun. 16, 2006 (JP) 2006-167477

(51) Int. Cl. C01F 17/00; C01B 33/00; C09C 1/62; C01B 31/04

(52) U.S. Cl. 423/263; 423/324; 423/448; 106/403

(57) ABSTRACT

A graphite spheroidizing agent capable of spheroidizing graphite while preventing formation of chunky graphite is provided. The graphite spheroidizing agent of the present invention comprising silicon, magnesium, calcium and rare earth elements, wherein the graphite spheroidizing agent contains rare earth elements of 0.6 to 3.0 mass % and a calcium content of 1.3 to 4.0 mass %, respectively, relative to the total amount thereof, and a percentage of lanthanum in the rare earth elements is 50 mass % or more.

### BACKGROUND OF THE INVENTION

1. Field of the Invention

The present invention relates to a graphite spheroidizing agent. More particularly, the present invention relates to a graphite spheroidizing agent used in order to spheroidize graphite in cast iron when producing spheroidal graphite cast iron.

2. Background Art

Spheroidal graphite cast iron is cast iron in which graphite is spherically crystallized as-cast. Since the graphite is spheroidized, the spheroidal graphite cast iron excels in mechanical properties (tensile strength, elongation, etc.) as compared with flake graphite cast iron.

As a method for manufacturing such spheroidal graphite cast iron, a method of reacting molten iron with a graphite spheroidizing agent in a ladle to carry out the treatment by crystallizing graphite in cast iron into a spherical form (graphite spheroidizing treatment) and casting the molten ion treated by the graphite spheroidizing treatment in a mold has been known (see e.g. JP-A-6-285612).

Pure magnesium or a magnesium-based alloy is used as such a graphite spheroidizing agent. For example, a graphite spheroidizing agent comprising a magnesium-based alloy containing silicon (Si), a rare earth element (RE), calcium (Ca), and the like has been disclosed (see e.g. JP-A-2000-303113).

The rare earth element (RE) contained in such a graphite spheroidizing agent is added in order to accelerate spheroidizing of graphite and to neutralize spheroidizing-inhibiting elements contained in molten iron, and there are usually used rare earth elements which are not extracted and purified into a single element, for example, a mixture containing 40 to 50 mass % of cerium (Ce), 20 to 40 mass % of lanthanum (La), 15 mass % or less of neodymium (Nd), and 5 mass % or less of praseodymium (Pr).

### SUMMARY OF THE INVENTION

However, the graphite spheroidizing agent containing rare earth elements (RE) had a problem that poor graphite (chunky graphite) which is in a state that powder of graphite are scattered was produced when a cast article with a relatively large thickness was cast.

Such a cast article in which chunky graphite is formed has impaired mechanical properties such as tensile strength, offset yield strength and elongation, and its product value is lowered due to appearance of powdery graphite (chunky graphite) on the processing surface on which a design is provided, for example.

Although it is possible to prevent formation of chunky graphite by reducing the content of rare earth elements (RE), the effect brought by containing the rare earth elements (RE) is reduced and oxidation and vaporization of magnesium is easily induced. Mechanical properties of the cast ion product are also inferior to a cast ion product in which the graphite are normally made spherical.

The present invention has been achieved in view of the above-mentioned problems, and provides a graphite spheroidizing agent capable of spheroidizing graphite while preventing formation of chunky graphite.

As a result of intensive study in order to achieve the above object, the inventors of the present invention have found that the magnesium fading time can be lengthened while preventing formation of chunky graphite by controlling the mass ratio of rare earth elements contained in a graphite spheroidizing agent and the mass ratio of lanthanum (La) in the rare earth elements in predetermined ranges and further that development of a quenching organization (chill) can be prevented by controlling the mass ratio of calcium (Ca) contained in the graphite spheroidizing agent in a predetermined range. These findings have led to the completion of the present invention.

Specifically, the present invention provides the following graphite spheroidizing agents.

[1] A graphite spheroidizing agent comprising silicon, magnesium, calcium and rare earth elements, wherein the graphite spheroidizing agent contains rare earth elements of 0.6 to 3.0 mass % and a calcium content of 1.3 to 4.0 mass %, respectively, relative to the total amount thereof, and a percentage of lanthanum in the rare earth elements is 50 mass % or more.

[2] The graphite spheroidizing agent according to [1], wherein the magnesium contained in the graphite spheroidizing agent is 3.0 to 8.0 mass %, relative to the total amount of the graphite spheroidizing agent.

[3] The graphite spheroidizing agent according to [1] or [2], wherein the silicon contained in the graphite spheroidizing agent is 40 to 70 mass %, relative to the total amount of the graphite spheroidizing agent.

[4] The graphite spheroidizing agent according to any one of [1] to [3], wherein the content of aluminum in the graphite spheroidizing agent is not more than 1.5 mass %, relative to the total amount of the graphite spheroidizing agent.

[5] The graphite spheroidizing agent according to any one of [1] to [4], wherein the percentage of lanthanum in the rare earth elements is 70 mass % or more.

[6] The graphite spheroidizing agent according to any one of [1] to [5], wherein the percentage of cerium in the rare earth elements is not more than 30 mass %.

[7] The graphite spheroidizing agent according to any one of [1] to [6], wherein the graphite spheroidizing agent is in a form of powder or lumps.

[8] The graphite spheroidizing agent according to any one of [1] to [7], which is used in a sandwich methods.

The graphite spheroidizing agent of the present invention can excellently make spheroidal graphite while preventing formation of chunky graphite.

### BRIEF DESCRIPTION OF THE DRAWINGS

FIG. 1(a) is a cross-sectional view showing the structure of a ladle used in a sandwich methods as one method for graphite spheroidizing treatment.

FIG. 1(b) is an enlarged view of the reaction chamber part of FIG. 1(a).

FIG. 2(a) shows a step during cast iron receiving in the converter method as one method for graphite spheroidizing treatment.

FIG. 2(b) shows a step during reaction in the converter method as one method for graphite spheroidizing treatment.

FIG. 2(c) shows a step during cast iron removing in the converter method as one method for graphite spheroidizing treatment.

FIG. 3 shows an elevation cross-section showing the structure of the ladle used in the Examples and Comparative Examples.

FIG. 4 is a microscopic photograph of the cross-section of the upper part test piece of the round block obtained in Example 1.

FIG. 5 is a microscopic photograph of the cross-section of the lower part test piece of the round block obtained in Example 1.

FIG. 6 is a microscopic photograph of the cross-section of the upper part test piece of the round block obtained in Example 2.

FIG. 7 is a microscopic photograph of the cross-section of the lower part test piece of the round block obtained in Example 2.

FIG. 8 is a microscopic photograph of the cross-section of the upper part test piece of the round block obtained in Example 3.

FIG. 9 is a microscopic photograph of the cross-section of the lower part test piece of the round block obtained in Example 3.

FIG. 10 is a microscopic photograph of the cross-section of the upper part test piece of the round block obtained in Example 4.

FIG. 11 is a microscopic photograph of the cross-section of the lower part test piece of the round block obtained in Example 4.

FIG. 12 is a microscopic photograph of the cross-section of the upper part test piece of the round block obtained in Comparative Example 1.

FIG. 13 is a microscopic photograph of the cross-section of the lower part test piece of the round block obtained in Comparative Example 1.

FIG. 14 is a microscopic photograph of the cross-section of the upper part test piece of the round block obtained in Comparative Example 2.

FIG. 15 is a microscopic photograph of the cross-section of the lower part test piece of the round block obtained in Comparative Example 2.

FIG. 16 is a microscopic photograph of the cross-section of the upper part test piece of the round block obtained in Comparative Example 3.

FIG. 17 is a microscopic photograph of the cross-section of the lower part test piece of the round block obtained in Comparative Example 3.

FIG. 18 is a microscopic photograph of the cross-section of the test piece (wall thickness: 50 mm) obtained in Comparative Example 1.

FIG. 19 is a microscopic photograph of the cross-section of the test piece (wall thickness: 50 mm) obtained in Comparative Example 2.

FIG. 20 is a microscopic photograph of the cross-section of the test piece (wall thickness: 50 mm) obtained in Comparative Example 3.

FIG. 21 is a graph showing the relationship between the wall thickness (mm) and the tensile strength (N/mm²) of the cast products obtained in Examples 1 to 4 and Comparative Example 1.

FIG. 22 is a graph showing the relationship between the wall thickness (mm) and the offset yield strength (N/mm²) of the cast products obtained in Examples 1 to 4 and Comparative Example 1.

FIG. 23 is a graph showing the relationship between the wall thickness (mm) and the elongation (%) of the cast products obtained in Examples 1 to 4 and Comparative Example 1.

### EXPLANATION OF NUMERALS

1, 11, 21: ladle, 2, 12, 22: reaction chamber, 3, 13: graphite spheroidizing agent, 4: cover material, 5, 15: molten cast iron, 16: lid, 30: refractory material, 31: dividing plate, and 32: pocket

### DETAILED DESCRIPTION OF THE INVENTION AND PREFERRED EMBODIMENT

Preferred embodiments of the graphite spheroidizing agent of the present invention will now be described. The present invention, however, should not be construed as being limited to these embodiments. Various alterations, modifications, and improvements are possible based on the knowledge of those skilled in the art, as long as there is no deviation from the scope of the present invention.

The graphite spheroidizing agent of this embodiment is used for spheroidizing graphite in cast iron when spheroidal graphite cast iron is produced. The graphite spheroidizing agent of the present invention comprises silicon (Si), magnesium (Mg), calcium (Ca) and rare earth elements (RE), in which the rare earth element (RE) content and calcium (Ca) content is respectively 0.6 to 3.0 mass % and 1.3 to 4.0 mass % relative to the total amount of the graphite spheroidizing agent and the rare earth elements (RE) include lanthanum (La) in an amount of 50 mass % or more.

In this manner, it is possible to excellently make spheroidal graphite while preventing formation of chunky graphite in a process of spheroidizing molten iron by using a graphite spheroidizing agent with a rare earth element (RE) content of 0.6 to 3.0 mass % relative to the total amount of the graphite spheroidizing agent, wherein the rare earth elements (RE) include lanthanum (La) in an amount of 50 mass % or more. Differing from the case, for example, in which the content of the whole of the rare earth element (RE) is decreased to prevent formation of chunky graphite, an increase of the lanthanum (La) content relative to the total amount of the graphite spheroidizing agent can prevent a reduction of the fading time of magnesium (Mg). In addition, mechanical properties such as tensile strength, offset yield strength, elongation, and the like of the resulting cast iron products are more excellent as compared with the case in which a conventional graphite spheroidizing agent containing rare earth elements (RE) is used.

Furthermore, the graphite spheroidizing agent of this embodiment can prevent formation of quenching organization (chill) so as to include 1.3 to 4.0 mass % of calcium (Ca) relative to the total amount of the graphite spheroidizing agent. If the calcium (Ca) content is less than 1.3 mass %, the effect of preventing chill development is insufficient. If the calcium (Ca) content is greater than 4.0 mass %, on the other hand, calcium (Ca) causes formation of a large amount of slag after the graphite spheroidizing processing. The removal of the slag thus formed takes times, and pin holes, inner slag defects and the like are formed due to its contamination with the cast product.

In addition, the graphite spheroidizing agent of this embodiment preferably contains 0.6 to 2.4 mass %, and more preferably 0.6 to 1.8 mass % of rare earth elements (RE) relative to the total amount of the graphite spheroidizing agent. Further, the content of lanthanum (La) in the rare earth elements (RE) is preferably 70 mass % or more, and more preferably 90 mass % or more. By composing like this, formation of chunky graphite can be excellently prevented and resulting cast products, even those having a thicker thickness or thinner thickness etc. of which the mechanical characteristics tend easily decrease, can be manufactured without impairing the mechanical characteristics. In addition, in this embodiment, the content of single lanthanum (La) relative to the total amount of the graphite spheroidizing agent is preferably 0.3 to 2.4 mass %, and more preferably 0.6 to 1.8 mass %.

As elements other than lanthanum (La) in the rare earth elements, cerium (Ce), neodymium (Nd), praseodymium (Pr), and the like can be given. In this embodiment of the graphite spheroidizing agent, the content of cerium (Ce) in the rare earth elements is preferably 30 mass % or less, more preferably 20 mass % or less, and particularly preferably 10 mass % or less. By composing like this, formation of chunky graphite can be more excellently prevented.

Furthermore, the content of calcium (Ca) included in the graphite spheroidizing agent is preferably 1.6 to 3.0 mass %, and more preferably 1.8 to 2.4 mass % relative to the total amount of the graphite spheroidizing agent. By composing like this, development of chill can be prevented while minimizing formation of slag.

Moreover, the graphite spheroidizing agent of this embodiment contains magnesium (Mg) and silicon (Si) in addition to the rare earth elements (RE) and calcium (Ca). Although not specifically limited, the content of magnesium (Mg) relative to the total amount of the graphite spheroidizing agent is preferably 3.0 to 8.0 mass %, and more preferably 4.5 to 6.0 mass %. When the content of magnesium (Mg) is less than 3.0 mass %, the amount of the graphite spheroidizing agent to be required for spheroidization becomes too much, and resultantly the economical efficiency and workability may be killed. On the other hand, if more than 8.0 mass %, the reaction proceeds so vigorously that the scattering of molten iron may often occur.

The content of silicon in the graphite spheroidizing agent is preferably 40 to 70 mass %, and more preferably 43 to 50 mass %. By composing like this, the formation of magnesium silicate-type dross and inner slag are minimized during spheroidizing treatment step to obtain pure molten cast iron.

Furthermore, the content of aluminum in the graphite spheroidizing agent of this embodiment is preferably not more than 1.5 mass %. By composing like this, the formation of pin holes can be prevented.

In addition, as components other than the above components forming the graphite spheroidizing agent, iron and the like can be given.

Moreover, the graphite spheroidizing agent of this embodiment can be applied to all conventionally known graphite spheroidizing methods. Specifically, an open lade treatment (also called sandwich methods), tundish method, converter method, and the like can be applied. The graphite spheroidizing agent of the present invention is most suitably used for the sandwich methods in that the method can be carried out in simple equipment and maintenance of equipment thereof makes it easy.

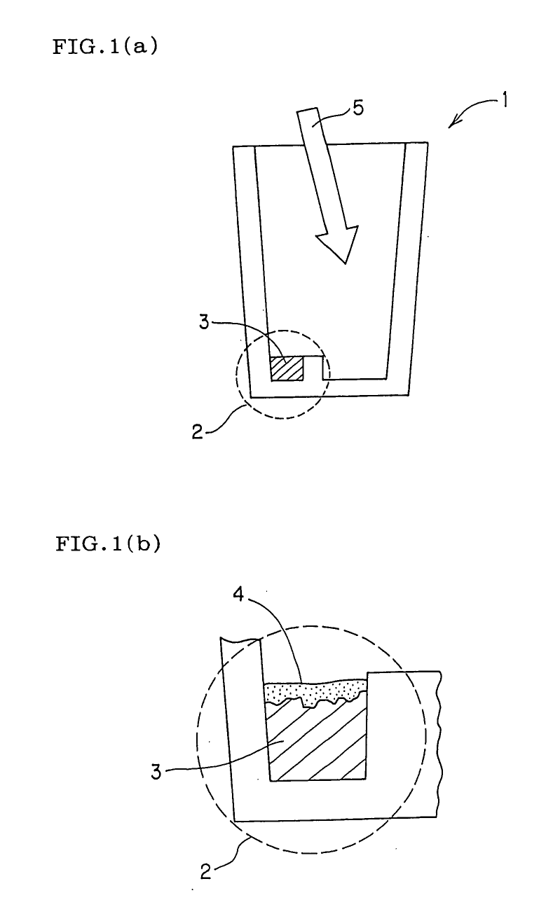

The sandwich methods is carried out using a ladle 1 with forming a pocket-like reaction chamber 2 in the bottom as shown in FIG. 1(a). A graphite spheroidizing agent 3 is filled in the reaction chamber 2 in the bottom of the ladle 1. Then, the upper surface of the graphite spheroidizing agent 3 is entirely covered with a cover material 4 (cutting powder, punch waste, steel plate, etc.) as shown in FIG. 1(b). After, a molten cast iron 5 is poured in the ladle 1, whereby the graphite spheroidizing agent 3 is dissolved in the molten cast iron 5 and the cover material 4 is also dissolved as well, the reaction is started to carry out the graphite spheroidizing treatment. In addition, a ladle with a relatively long trunk is preferably used in the sandwich methods, because such a ladle ensures the reaction to proceed without fail in the molten cast iron and increases the yield of magnesium (Mg) remaining in the molten cast iron. An inoculation agent may be provided between the graphite spheroidizing agent 3 and the cover material 4.

The tundish method is carried out using a ladle equipped with a molten-iron-receiving-container (tundish) that also functions as a lid and is mounted so as to seal the upper opening of the ladle. The tundish method is characterized by pouring the molten cast iron into the ladle via a molten-iron-receiving-container, with other steps which are the same as those of the sandwich methods.

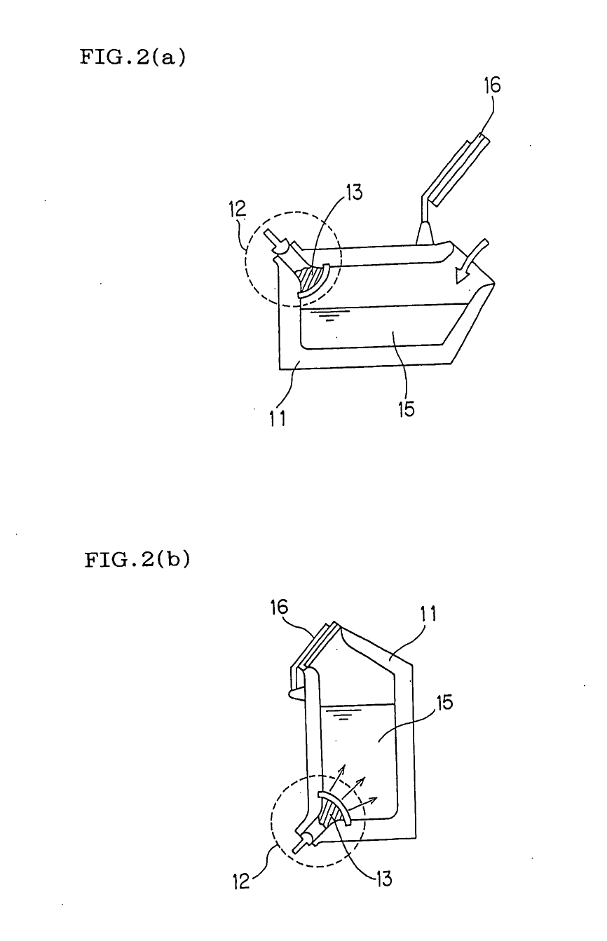

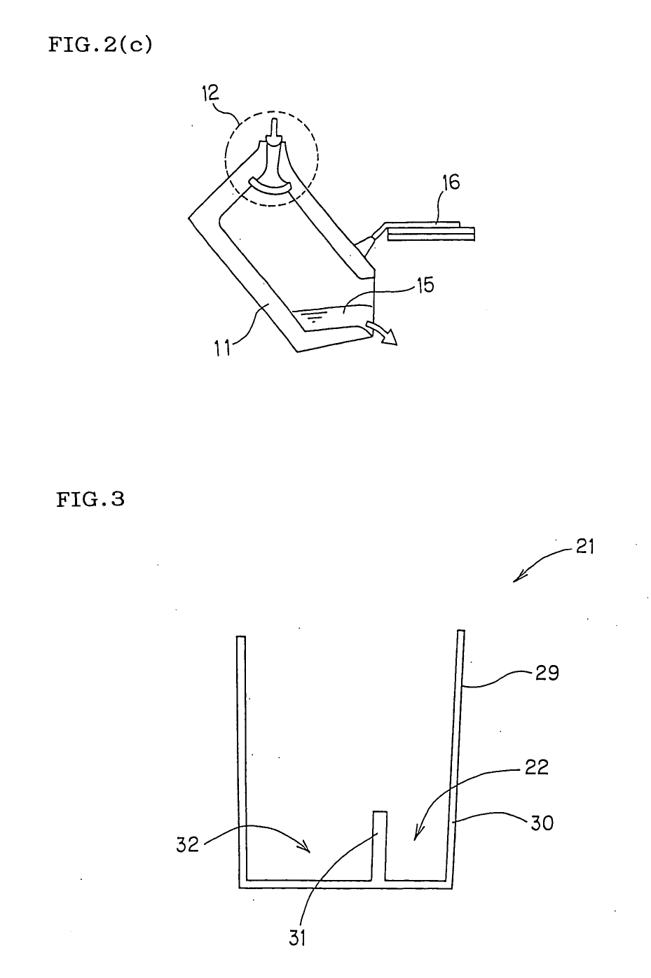

The converter method is carried out using an inclinable ladle 11 (called a converter) which is provided with a reaction chamber 12 in the bottom as shown in FIGS. 2(a) to 2(c). Firstly, as shown in FIG. 2(a), a graphite spheroidizing agent 13 is filled into the reaction chamber 12 in the bottom of the ladle 11 in a state which is layed on its side and a molten cast iron 15 is poured therein (receiving molten iron). Next, the graphite spheroidizing agent 13 and molten cast iron 15 are caused to come into contact with each other in the reaction chamber 12, in a state which the ladle 11 is held inclined and covered with a lid 16, as shown in FIG. 2(b), and thereby the graphite spheroidizing agent 13 and the molten cast iron 15 are reacted to carry out the graphite spheroidizing treatment (reaction). Lastly, the molten cast iron 15 after the graphite spheroidizing treatment is removed by turning the ladle 11 again as shown in FIG. 2(c) (removing molten iron).

The molten cast iron which has been treated by the graphite spheroidizing process as the above-mentioned is cased in a mold and thereby a spheroidal graphite cast iron product with a desired shape can be prepared.

There are no specific limitations to the form of the graphite spheroidizing agent of this embodiment. Any appropriate shape according to the method of graphite spheroidizing treatment, for example, can be determined, and there is mentioned powder or lumps as a preferable example. When the sandwich methods is performed for graphite spheroidizing treatment, for example, the graphite spheroidizing agent is preferably in a form that can be filled in the reaction chamber formed in the bottom of the ladle to be used.

In addition, the graphite spheroidizing agent of this embodiment can be suitably used not only for the manufacture of spheroidal graphite cast iron, but also for the manufacture of CV (compacted vermicular) graphite cast iron. Differing from the case of spheroidal graphite cast iron (graphite spheroidizing rate: more than 70%), the graphite of CV graphite cast iron is not completely spheroidized (graphite spheroidizing rate: 40 to 70%), but is crystallized in the shape of a caterpillar. Therefore, the CV graphite cast iron excels in casting properties and heat conductivity, while possessing the same superior mechanical characteristics as spheroidal graphite cast iron.

### EXAMPLES

The present invention is described below in detail based on examples. However, the present invention is not limited to the following examples.

In the following Examples and Comparative Examples, graphite spheroidizing treatment was carried out by producing graphite spheroidizing agents with different compositions and reacting graphite spheroidizing agent with molten cast iron in a ladle. The molten cast iron treated by the graphite spheroidizing treatment was cased into a mold with a prescribed shape to produce cast products of spheroidal graphite cast iron. The tensile strength, offset yield strength, elongation, and cross-sectional state of the resulting cast products were compared to evaluate the effects of the present invention. In addition, in view of the fact that chunky graphite can be easily formed when cast into an article with a relatively thick wall, the effects of the present invention were evaluated by comparing tensile strength, offset yield strength, elongation, and cross-sectional state as to the cast products having a wall thickness in four levels of 8 mm, 25 mm, 50 mm, and 100 mm, respectively.

### Example 1

The graphite spheroidizing agent was prepared from 46 mass % of silicon (Si), 5 mass % of magnesium (Mg), 2.2 mass % of calcium (Ca), 0.6 mass % of rare earth elements (RE), 0.3 mass % of aluminum (Al), and iron (Fe), and the like as a balance. In the graphite spheroidizing agent of Example 1, the percentage of lanthanum (La) in the rare earth elements (RE) was 100 mass %. The compositions of the graphite spheroidizing agents are shown in Table 1.

TABLE 1

| | Composition of graphite spheroidizing agent | | | | | Content of La |
|---|---|---|---|---|---|---|
| | | | | Rare earth | | for total rare |
| | Si | Mg | Ca | elements | Al | earth elements |
| | (mass %) | (mass %) | (mass %) | (mass %) | (mass %) | (mass %) |
| Example 1 | 46 | 5.0 | 2.2 | 0.6 | 0.3 | 100 |
| Example 2 | 46 | 5.0 | 2.2 | 1.8 | 0.3 | 50 |
| Example 3 | 46 | 5.0 | 2.2 | 1.8 | 0.3 | 70 |
| Example 4 | 46 | 5.0 | 2.2 | 1.8 | 0.3 | 90 |
| Comparative | 46 | 5.0 | 2.2 | 1.8 | 0.3 | 30 |
| Example 1 | | | | | | |
| Comparative | 46 | 5.0 | 0.4 | 0.6 | 0.3 | 100 |
| Example 2 | | | | | | |
| Comparative | 46 | 5.0 | 1.2 | 0.6 | 0.3 | 100 |
| Example 3 | | | | | | |

The open lade treatment (also called a sandwich methods) was used as the graphite spheroidizing method. As the ladle, a ladle 21 (an internal volume: about 50l) with a pocket-like reaction chamber 22 formed in the bottom as shown in FIG. 3 was used. In FIG. 3, the reference numeral 29 indicates a ladle body, 30 indicates a refractory material, 31 indicates a dividing plate, and 32 indicates a pocket.

A graphite spheroidizing agent in an amount equivalent to 1 mass % of the total amount of the molten cast iron used was filled in the reaction chamber 22 in the bottom of the ladle. The upper surface of the graphite spheroidizing agent filled was entirely covered with an inoculating agent and a cover material. The inoculating agent, consisting of 75 mass % of silicon (Si), 0.5 mass % of calcium (Ca), and 2 mass % of aluminum (Al), with the balance being iron (Fe) (total: 100 mass %), was used in an amount equivalent to 0.3 mass % of the total amount of the molten cast iron. Cut powder of spheroidal graphite cast iron in an amount equivalent to 1 mass % relative to the total amount of the molten cast iron was used as the cover material.

Then, 50 kg of molten cast iron was poured into the ladle from a port and carried out graphite spheroidizing treatment for several seconds under atmospheric pressure condition. The exit temperature of the molten cast iron was 1,500° C. and the cast iron pouring temperature was 1,385 to 1,400° C.

Molten cast iron melted in a high frequency melting furnace with a component composition that can produce the target cast iron product with a component as shown in Table 2 was used as the molten cast iron in this Example.

TABLE 2

| Component | Content (mass %) |
|---|---|
| C | 3.60 |
| Si | 2.50 |
| Mn | 0.40 |
| Mg | 0.038 |
| S | 0.010 |
| Cu | 0.50 |
| Cr | 0.040 |
| P | 0.050 |
| Fe | Balance |

A cylindrical test block (hereinafter referred to “round block”) was produced by casting the molten cast iron processed by the graphite spheroidizing treatment into a cylindrical mold having a thickness of 100 mm and a diameter of 200 mm.

Test pieces were prepared from the resulting round block according to the method of JIS Z2201. Tensile strength (N/mm²), offset yield strength (N/mm²), and elongation (%) were evaluated using the resulting test pieces. The measurement results are shown in Table 3. In addition, the tensile strength (N/mm²), offset yield strength (N/mm²), and elongation (%) were measured according to the method of JIS Z2241.

TABLE 3

| | Round block measurement results | | |
|---|---|---|---|
| | Tensile strength | Offset yield strength | Elongation |
| | (N/mm^{2‘)} | (N/mm²) | (%) |
| Example 1 | 635 | 405 | 6.7 |
| Example 2 | 609 | 410 | 5.1 |
| Example 3 | 605 | 406 | 4.4 |
| Example 4 | 613 | 406 | 4.7 |
| Comparative Example 1 | 602 | 400 | 4.0 |
| Comparative Example 2 | 544 | 386 | 5.1 |
| Comparative Example 3 | 589 | 397 | 6.5 |

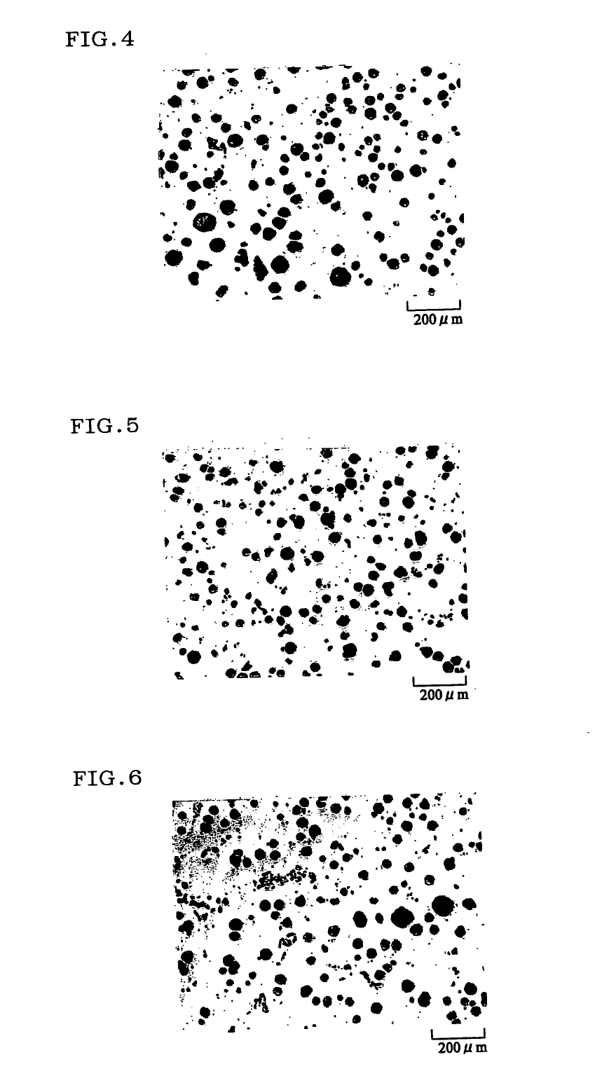

The resulting round block was cut in the thickness direction to obtain an upper surface side (upper part) and a bottom side (lower part) as test pieces, and then the cross-sections were of each of the test pieces observed by electron microscope to confirm the graphite spheroidizing states and formation or non-formation of chunky graphite. FIG. 4 is a microscopic photograph of the cross-section of the upper part test piece of the round block obtained in Example 1 and FIG. 5 is a microscopic photograph of the cross-section of the lower part test piece of the round block obtained in Example 1.

Furthermore, rectangular parallelepiped test blocks (I-blocks) were prepared from the same molten cast iron. Four I-blocks of cast iron products having a different thickness were prepared. The I-blocks had a size of a length of 250 mm, a width of 150 mm, and a wall thickness of 8 mm, 25 mm, 50 mm, or 100 mm.

Tensile strength (N/mm²), offset yield strength (N/mm²), and elongation (%) of the resulting I-blocks were evaluated in the same manner as the round block. Measurement results in the case in which the wall thickness was 25 mm are shown in Table 4.

TABLE 4

| | I-block measurement results | | |
|---|---|---|---|
| | Tensile strength | Offset yield strength | Elongation |
| | (N/mm²) | (N/mm²) | (%) |
| Example 1 | 754 | 457 | 11.5 |
| Example 2 | 751 | 456 | 8.3 |
| Example 3 | 740 | 450 | 9.0 |
| Example 4 | 763 | 458 | 8.8 |
| Comparative Example 1 | 735 | 427 | 7.9 |
| Comparative Example 2 | 722 | 447 | 10.8 |
| Comparative Example 3 | 727 | 445 | 9.2 |

A chill examination was carried out by preparing a C4 test piece of the Japan Foundry Society, Inc. and measuring the length from the point at which chill is no longer formed to the point of one of the ends of the resulting test piece. The measurement results are shown in Table 5.

TABLE 5

| | Chill depth (mm) |
|---|---|
| Example 1 | 18.6 |
| Comparative Example 1 | 22.5 |
| Comparative Example 2 | 35.1 |
| Comparative Example 3 | 30.3 |

### Examples 2 to 4

Graphite spheroidizing agents were prepared in the same manner as in Example 1, except that the amount of rare earth elements relative to the total amount of the graphite spheroidizing agents was 1.8 mass % and the percentage of lanthanum (La) in the rare earth elements was 50 mass % in Example 2, 70 mass % in Example 3, and 90 mass % in Example 4. Round blocks and I-blocks were cast in the same manner as in Example 1 using the resulting graphite spheroidizing agents to measure tensile strength (N/mm²), offset yield strength (N/mm²), and elongation (%). The measurement results are shown in Tables 3 and 4.

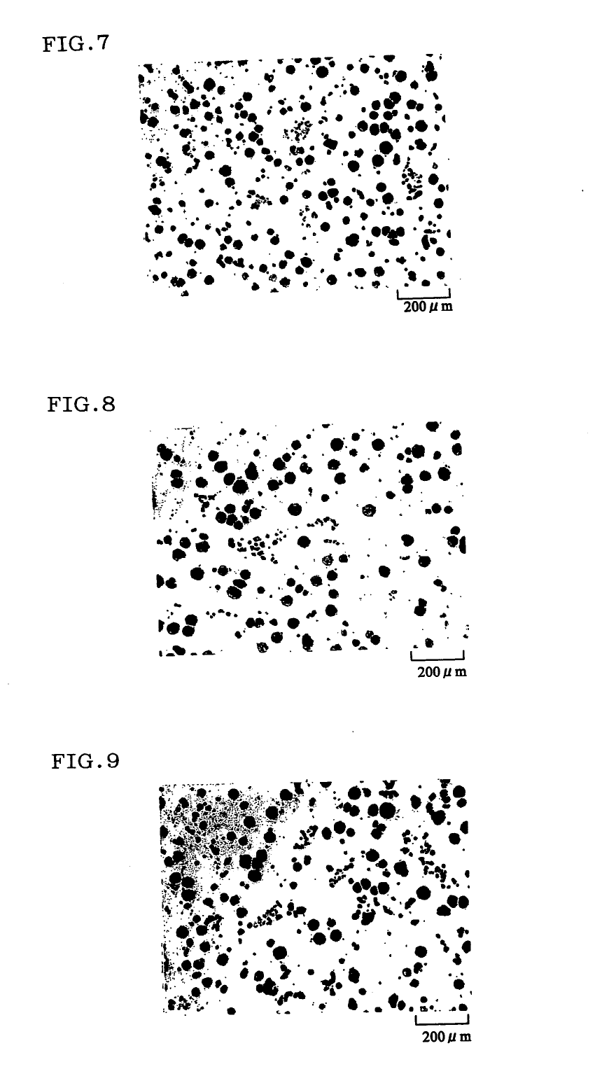

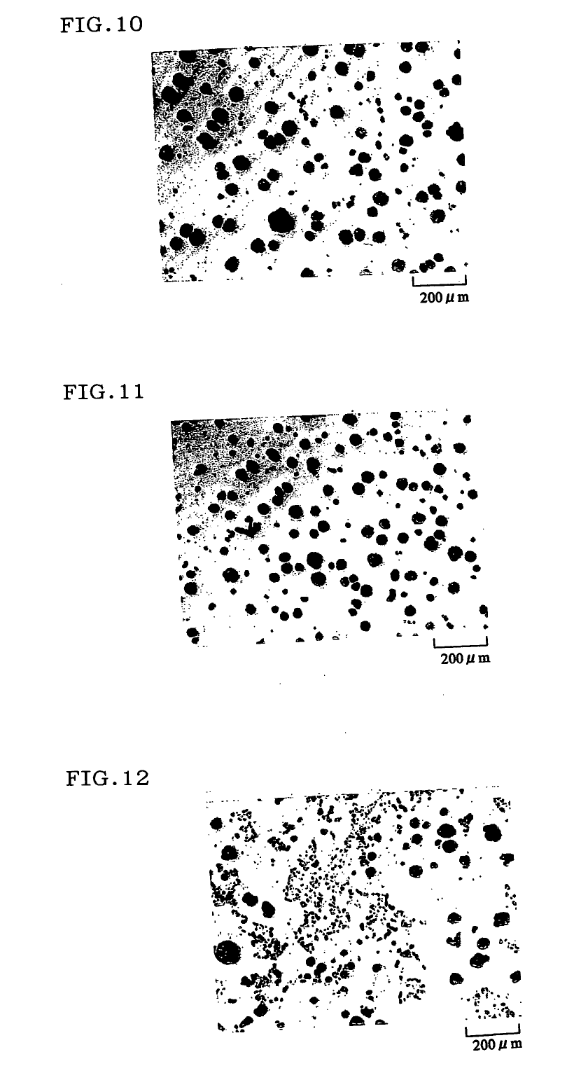

The resulting round blocks were cut in the thickness direction to obtain an upper surface side (upper part) and a bottom side (lower part) as test pieces, and then the cross-sections of each of the test pieces were observed by electron microscope to confirm the graphite spheroidizing states and formation or non- formation of chunky graphite. FIG. 6 is a microscopic photograph of the cross-section of the upper part test piece of the round block obtained in Example 2, FIG. 7 is a microscopic photograph of the cross-section of the lower part test piece of the round block obtained in Example 2, FIG. 8 is a microscopic photograph of the cross-section of the upper part test piece of the round block obtained in Example 3, FIG. 9 is a microscopic photograph of the cross-section of the lower part test piece of the round block obtained in Example 3, FIG. 10 is a microscopic photograph of the cross-section of the upper part test piece of the round block obtained in Example 4, and FIG. 11 is a microscopic photograph of the cross-section of the lower part test piece of the round block obtained in Example 4.

### Comparative Example 1

A graphite spheroidizing agent was prepared in the same manner as in Example 1, except that the amount of rare earth elements relative to the total amount of the graphite spheroidizing agent was 1.8 mass % and the percentage of lanthanum (La) in the rare earth elements was 30 mass %. A round block and I-blocks were cast in the same manner as in Example 1 using the resulting graphite spheroidizing agent to measure tensile strength (N/mm²), offset yield strength (N/mm²), elongation (%), and chill length. The measurement results are shown in Tables 3 to 5.

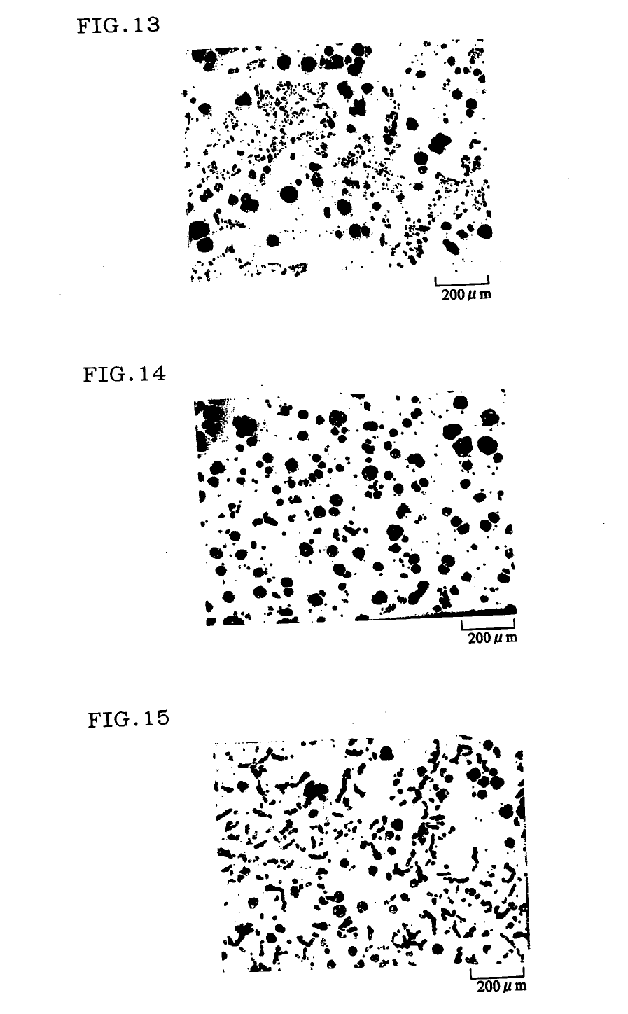

The resulting round block was cut in the thickness direction to obtain an upper surface side (upper part) and a bottom side (lower part) as test pieces, and then the cross-sections of each of the test pieces were observed by electron microscope to confirm the graphite spheroidizing states and formation or non- formation of chunky graphite. FIG. 12 is a microscopic photograph of the cross-section of the upper part test piece of the round block obtained in Comparative Example 1 and FIG. 13 is a microscopic photograph of the cross-section of the lower part test piece of the round block obtained in Comparative Example 1.

### Comparative Examples 2 and 3

Graphite spheroidizing agents were prepared in the same manner as in Example 1, except that the amount of calcium relative to the total amount of the graphite spheroidizing agent was 0.4 mass % in Comparative Example 2 and 1.2 mass % in Comparative Example 3. Round blocks and I-blocks were cast in the same manner as in Example 1 using the resulting graphite spheroidizing agents to measure tensile strength (N/mm²), offset yield strength (N/mm²), elongation (%), and chill length. The measurement results are shown in Tables 3 to 5.

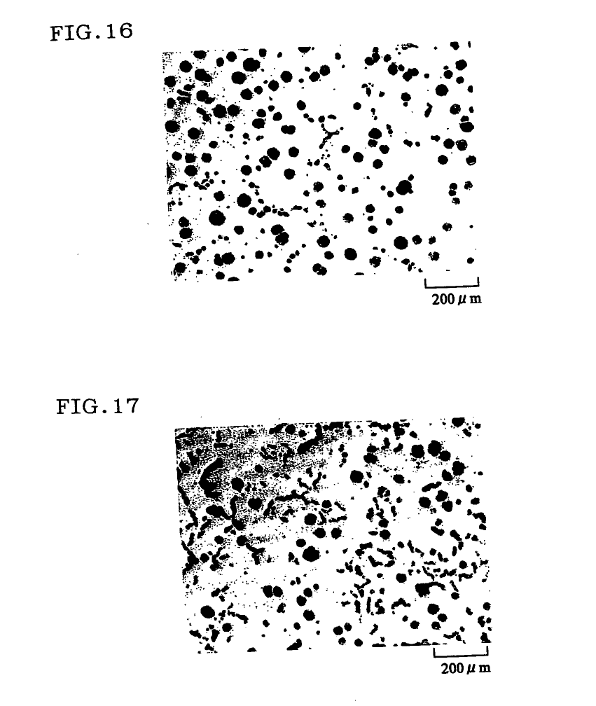

The resulting round blocks were cut in the thickness direction to obtain an upper surface side (upper part) and a bottom side (lower part) as test pieces, and then the cross-sections of each of the test pieces were observed by electron microscope to confirm the graphite spheroidizing states and formation or non- formation of chunky graphite. FIG. 14 is a microscopic photograph of the cross-section of the upper part test piece of the round block obtained in Comparative Example 2, FIG. 15 is a microscopic photograph of the cross-section of the lower part test piece of the round block obtained in Comparative Example 2, FIG. 16 is a microscopic photograph of the cross-section of the upper part test piece of the round block obtained in Comparative Example 3, and FIG. 17 is a microscopic photograph of the cross-section of the lower part test piece of the round block obtained in Comparative Example 3.

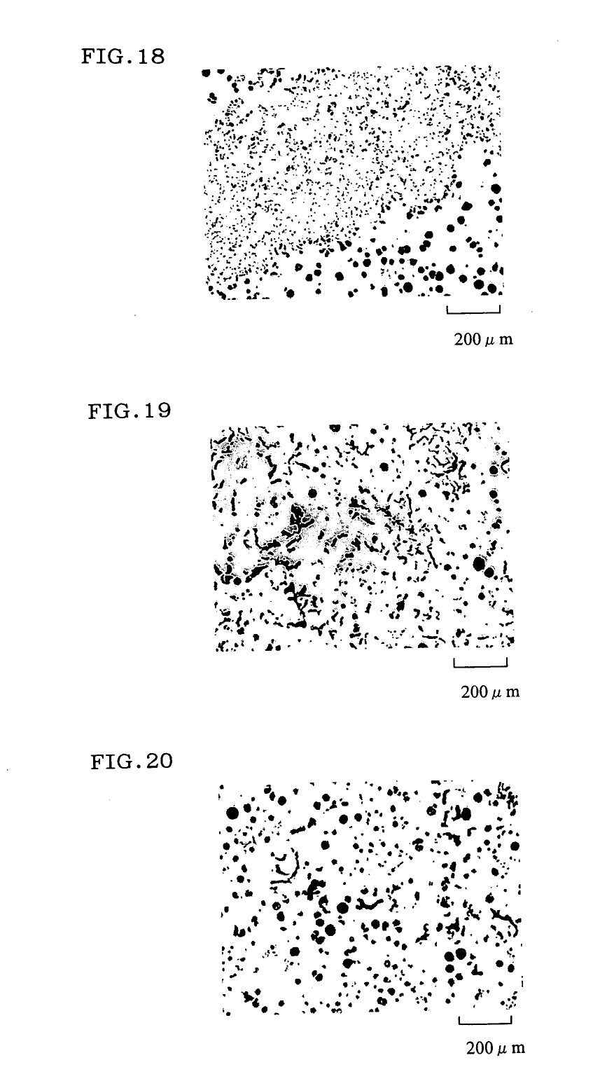

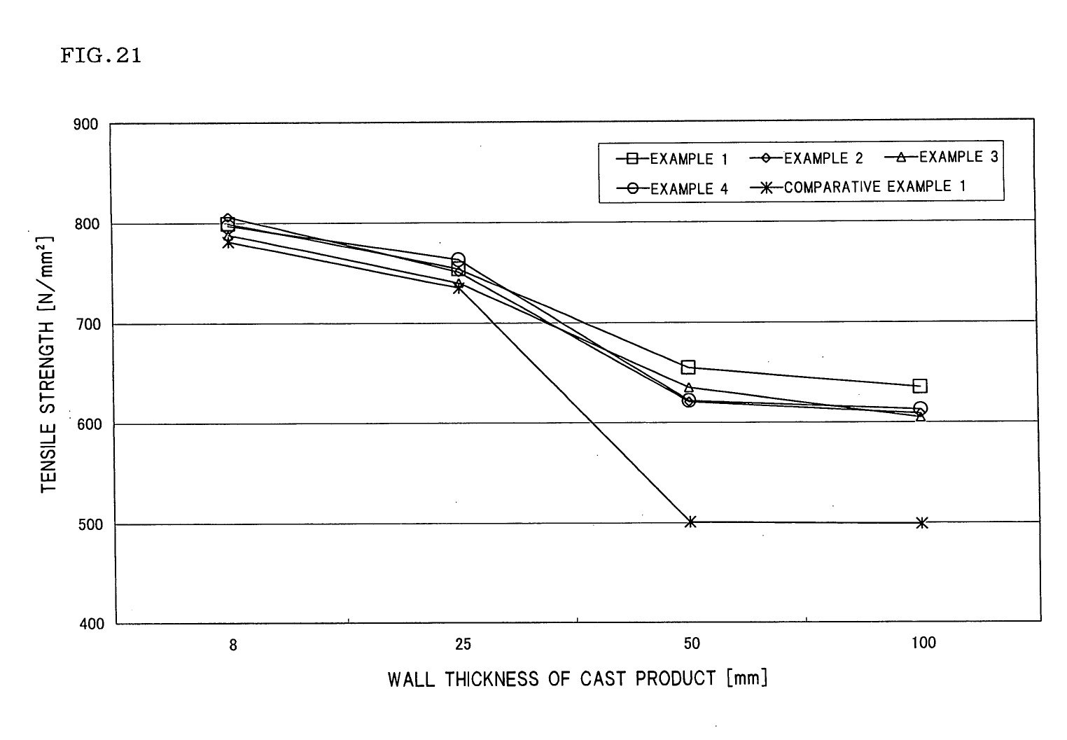

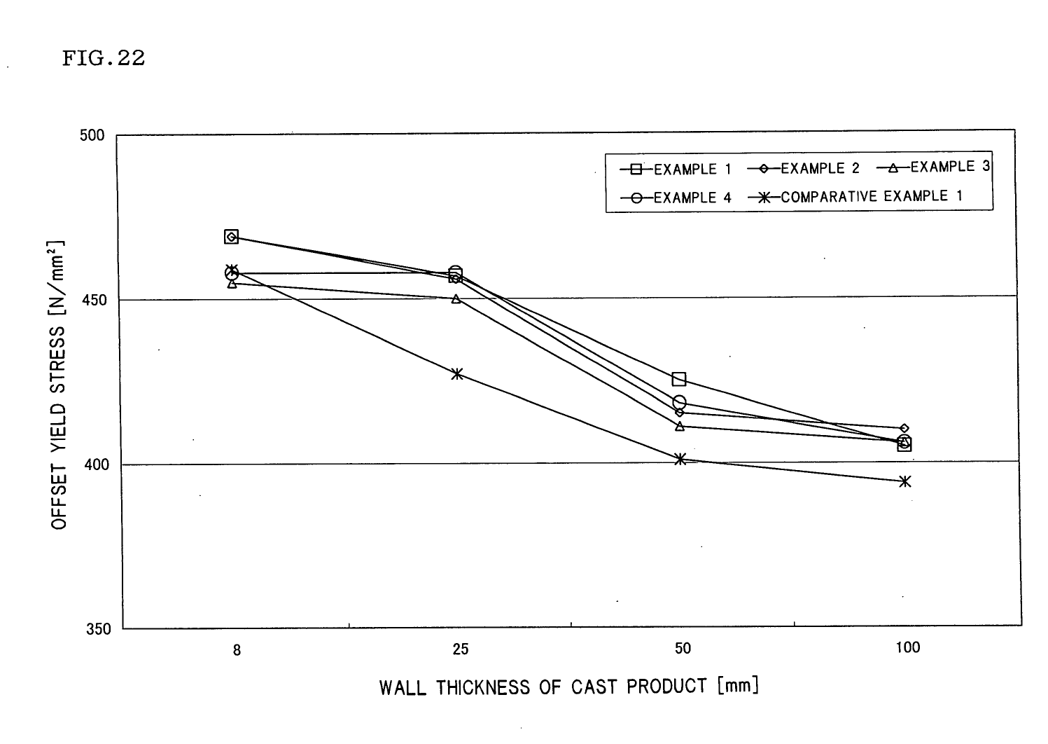

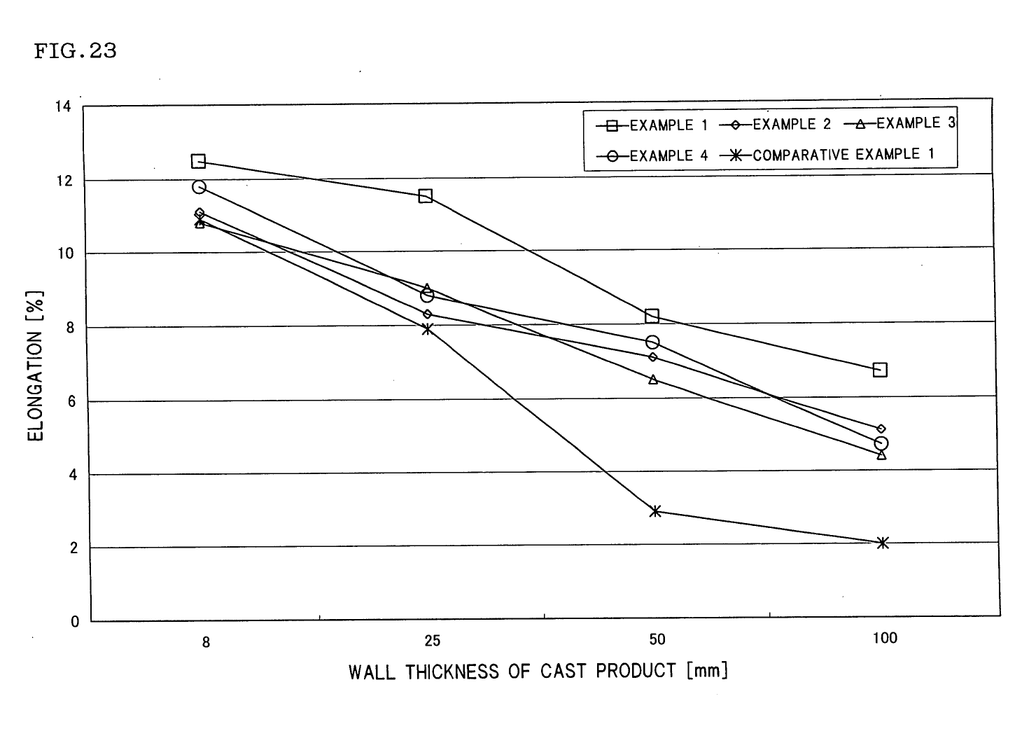

The results of evaluation of tensile strength (N/mm²), offset yield strength (N/mm²), and elongation (%) on each of the four cast products (I-blocks) having a wall thickness of 8 mm, 25 mm, 50 mm, and 100 mm prepared in Examples 1 to 4 and Comparative Example 1 are shown in Tables 6 to 8. Table 6 shows the results of tensile strength measurement, Table 7 shows the result of offset yield strength measurement, and Table 8 shows the result of elongation measurement. FIG. 21 is a graph showing the relationship between the wall thickness (mm) and the tensile strength (N/mm²) of the cast products obtained in Examples 1 to 4 and Comparative Example 1, FIG. 22 is a graph showing the relationship between the wall thickness (mm) and the offset yield strength (N/mm²) of the cast products obtained in Examples 1 to 4 and Comparative Example 1, and FIG. 23 is a graph showing the relationship between the wall thickness (mm) and the elongation (%) of the cast products obtained in Examples 1 to 4 and Comparative Example 1. Test pieces were prepared by cutting a part of cast products having a wall thickness of 50 mm in Comparative Examples 1 to 3 and their cross-sections were observed by electron microscope to confirm graphite spheroidizing states and formation or non- formation of chunky graphite. FIG. 18 is a microscopic photograph of the cross-section of the test piece (wall thickness: 50 mm) obtained in Comparative Example 1, FIG. 19 is a microscopic photograph of the cross-section of the test piece (wall thickness: 50 mm) obtained in Comparative Example 2, and FIG. 20 is a microscopic photograph of the cross-section of the test piece (wall thickness: 50 mm) obtained in Comparative Example 3.

TABLE 6

| Tensile strength | Wall thickness | | | |
|---|---|---|---|---|
| (N/mm²) | 8 mm | 25 mm | 50 mm | 100 mm |
| Example 1 | 799 | 754 | 655 | 635 |
| Example 2 | 806 | 751 | 621 | 609 |
| Example 3 | 788 | 740 | 635 | 605 |
| Example 4 | 797 | 763 | 622 | 613 |
| Comparative Example 1 | 781 | 735 | 501 | 499 |

TABLE 7

| Offset yield strength | Wall thickness | | | |
|---|---|---|---|---|
| (N/mm²) | 8 mm | 25 mm | 50 mm | 100 mm |
| Example 1 | 469 | 457 | 425 | 405 |
| Example 2 | 469 | 456 | 415 | 410 |
| Example 3 | 455 | 450 | 411 | 406 |
| Example 4 | 458 | 458 | 418 | 406 |
| Comparative Example 1 | 459 | 427 | 401 | 394 |

TABLE 8

| Elongation | Wall thickness | | | |
|---|---|---|---|---|
| (%) | 8 mm | 25 mm | 50 mm | 100 mm |
| Example 1 | 12.5 | 11.5 | 8.2 | 6.7 |
| Example 2 | 11.1 | 8.3 | 7.1 | 5.1 |
| Example 3 | 10.8 | 9.0 | 6.5 | 4.4 |
| Example 4 | 11.8 | 8.8 | 7.5 | 4.7 |
| Comparative Example 1 | 10.9 | 7.9 | 2.9 | 2.0 |

As can be seen from the measurement results shown in Tables 6 to 8 and the graphs shown in FIGS. 21 to 23, the cast products prepared in Examples 1 to 4 and Comparative Example 1 exhibited better results when the wall thickness was the thinnest (8 mm), and all of the tensile strength, offset yield strength, and elongation decreased as the wall thickness increases. Among these, the cast products of Examples 1 to 4 in which the graphite spheroidizing agent of the present invention was used showed more moderate decrease in tensile strength, offset yield strength, and elongation in case of the increase of the wall thickness as compared with the product of Comparative Example 1, it was confirmed effective prevention of formation of chunky graphite or development chill in cast products having a relatively large wall thickness in which chunky graphite is easily formed. In particular, a drastic decrease in tensile strength, offset yield strength, and elongation can be confirmed in the cast product of Comparative Example 1 when the wall thickness exceeds 25 mm. However, the decrease in tensile strength, offset yield stress, and elongation was moderate in the cast products of Examples 1 to 4.

Furthermore, as can be seen from Table 5, the cast products of Comparative Examples 2 and 3 in which graphite spheroidizing agents with a low calcium content were used (0.4 mass % in Comparative Example 2 and 1.2 mass % in Comparative Example 3) exhibited a significantly great chill depth (mm) as compared with Example 1, it was confirmed that chill development can be prevented by using the graphite spheroidizing agent of the present invention.

The graphite spheroidizing agent of the present invention can suitably be used for producing spheroidal graphite cast iron in which formation of chunky graphite and development of chill are prevented.

What is claimed is:

1. A graphite spheroidizing agent comprising silicon, magnesium, calcium and rare earth elements, wherein the graphite spheroidizing agent contains rare earth elements of 0.6 to 3.0 mass % and a calcium content of 1.3 to 4.0 mass %, respectively, relative to the total amount thereof, and a percentage of lanthanum in the rare earth elements is 50 mass % or more.

2. The graphite spheroidizing agent according to claim 1, wherein the magnesium contained in the graphite spheroidizing agent is 3.0 to 8.0 mass %, relative to the total amount of the graphite spheroidizing agent.

3. The graphite spheroidizing agent according to claim 1, wherein the silicon contained in the graphite spheroidizing agent is 40 to 70 mass %, relative to the total amount of the graphite spheroidizing agent.

4. The graphite spheroidizing agent according to claim 1, wherein the content of aluminum in the graphite spheroidizing agent is not more than 1.5 mass %, relative to the total amount of the graphite spheroidizing agent.

5. The graphite spheroidizing agent according to claim 1, wherein the percentage of lanthanum in the rare earth elements is 70 mass % or more.

6. The graphite spheroidizing agent according to claim 1, wherein the percentage of cerium in the rare earth elements is not more than 30 mass %.

7. The graphite spheroidizing agent according to claim 1, wherein the graphite spheroidizing agent is in a form of powder or lumps.

8. The graphite spheroidizing agent according to claim 1, which is used in a sandwich methods.
